(19) United States
(12) Patent Application Publication
(10) Pub. No.: US 2009/0154671 A1
(43) Pub. Date: Jun. 18, 2009

(54) COMMUNICATION SYSTEM AND METHOD

(75) Inventors: Tom Weiss, London (GB); Matthew Karas, London (GB); Jonathan Ellis, London (GB); Simon Waterfall, London (GB); Toby Russell Constantine, London (GB); Neill Wilkinson, London (GB); Christopher Paul Deering, London (GB); Neill Gordon Peplow, London (GB); Stephen William Giray Cooke, London (GB)

Correspondence Address: Leason Ellis LLP, 81 Main Street, Suite 503, White Plains, NY, 10601, US

(73) Assignee: Psygnificant Services Limited, Westminister (GB)

(21) Appl. No.: 12/252,801

(22) Filed: Oct. 16, 2008

(30) Foreign Application Priority Data
Oct. 16, 2007 (GB) 0720222.9
May 1, 2008 (GB) 0808015.2

(51) Int. Cl. H04M 11/00

(52) U.S. Cl. 379/93.02; 379/93.01

(57) ABSTRACT

A communication system is disclosed which is arranged to cause establishment of a connection between a first system that is a party to a call, or is a party to a call being initiated, and a second system. The first and second systems are arranged to communicate via said connection. The communication comprises a data dialogue that is separate to initiation communications for the call. At least one of the first system and the second system is arranged to store data, or to cause a change to an application or data or process in dependence on the data dialogue. A corresponding method is also disclosed.

### FIELD OF THE INVENTION

The present invention relates to a communication system and method and is particularly applicable to communications and management of calls originating from mobile telephones, computer based communication systems and the like.

### BACKGROUND OF THE INVENTION

Numerous different mechanisms are used in today's lives for communication. A communication made using one of these mechanisms is referred to herein as a call. Mechanisms used include standard telephone calls over mobile and fixed line networks. Internet or network based calls typically use voice over Internet Protocols, VoIP. Other mechanisms also exist such as video-phone calls, chat sessions (text based or otherwise), and application-sharing sessions when an application on a single machine can be controlled by two users, one of whom is on a remote machine.

All of these mechanisms have at least three phases that occur in sequence: initiation phase; communication phase; and, termination phase.

Whilst the initiation and termination phases will include transmission of data that could be considered “communication”, the communication phase referred to in this document is intended to refer to the (typically synchronous) interaction between users once a call has been initiated by one party and accepted by another. For example, in a telephone call, the communication phase is where a switched connection exists after the recipient has accepted the call and the originator and recipient are able to talk to each other.

The termination phase includes resource recovery, billing and the like. This phase is not particularly relevant to the present invention and therefore is not described further.

The initiation phase is triggered by a party (referred to hereafter as the “originator”) initiating the call and defining the identity (for example, a telephone number) of at least one other party (referred to hereafter as a “recipient”).

In this document the terms ‘originator’ and ‘recipient’ are taken to include operatives and/or systems responsible for initiating or answering a call respectively. Although expressed in the singular, both terms shall be taken to include the plural and vice-versa.

Typically, once the originator initiates a call, a connection is established with the recipient via data communication referred to as a “handshake” Handshakes are typically transparent to the end-users and dealt with by the underlying communication mechanisms. During the handshake, the originator and recipient and any necessary intermediate systems exchange data necessary for the communication phase to start. In connection-oriented communications, the handshake stage may also include negotiation of necessary facilities such as bandwidth with intermediate systems to support and route data during the communication phase.

Once initiated, the status of call set-up may be indicated to the originator by various methods (typically a ringing tone or, in the case of a network fault, a voice message describing the fault), such indication being referred to hereinafter as ‘ringback’. Note that in current technologies, ringback is restricted to information relating to the establishment of the communication phase: i.e. whether the call is being connected, awaiting answer, or unable to complete (either because the recipient is engaged or because there is a fault).

When the recipient receives a handshake, an appropriate notification is typically provided to alert the recipient of the requested call. The recipient accepts the call in the manner appropriate to the communication system (picking up the phone, pressing a button, accepting a prompt from a user interface etc.). The manner of notification typically depends on the nature and facilities of the recipient system.

In complex systems such as call centres, aspects of the notification may be delayed until after the commencement of the communication phase, while appropriate processing of the call is performed to route it to the appropriate destination. For example, it is common for call centres to operate Interactive Voice Response (IVR) systems and other automated routing systems that accept prompts from the originator to identify the appropriate recipient. In this situation, a notification is provided to the IVR system which accepts the call and starts the communication phase. Once the IVR system is navigated by the originator and the recipient is identified, the IVR system transfers the call to the recipient's system and a further notification is generated at the recipient system.

Routing via IVR systems and the like is typically considered part of the communication phase as far as the network and billing is concerned (as the call has been accepted and is being processed and routed internally by the call centre).

The initiation phase of standard fixed line voice calls, made over PSTN or ISDN systems, involves the sending of a call-setup packet of data usually referred to as the Calling Line Identifier CLI, although it contains more information than just the telephone number of the originating system, to the recipient's system. During the transmission of the CLI, switches within the telephone network are configured to establish a connection. There are variations to the format of the call-setup data on different systems, although these are largely interoperable.

Mobile telephone networks, such as those based on GSM, CODMA or UMTS systems, use similar CLI formats to that of fixed line systems. However, due to the technology needed to establish a wireless connection, mobile telephones tend to be much more sophisticated than fixed line telephones.

VoIP systems are very varied in the way in which they are implemented, but the usual approach has an initiation phase in which the originating and recipient systems exchange a small amount of data in a format defined by a set of rules, often using the standardised Session Initiation Protocol, SIP.

IP technology allows text-based chat, video-calls and the use of shared graphical environments. With respect to session initiation, these are typically implemented in the same way as VoIP.

### SUMMARY OF THE INVENTION

According to an aspect of the present invention, there is provided a communication system arranged to cause establishment of a connection between a first system that is a party to a call, or is a party to a call being initiated, and a second system, wherein the first and second systems are arranged to communicate via said connection, the communication comprising a data dialogue that is separate to initiation communications for the call, wherein at least one of the first system and the second system is arranged to store data, or to cause a change to an application or data or process in dependence on the data dialogue.

Preferably, the data dialogue is separate to the call, although it could be multiplexed in-band within the call.

The data dialogue may include each of the first and second systems receiving data from the other respective system and responding in dependence on the received data. Preferably, either of the first or second system is able to take control of the data dialogue.

The communications system may further comprise a management system arranged to manage and/or monitor at least aspects of the call, the management system being arranged to cause establishment of the connection. The management system may be part of an application on each (or one of) the user's system. Functionality could also be distributed such that at least some functionality is remote of the user's system.

Preferably, the communications system is arranged to cause establishment of the connection upon receiving initiation data on the call at the first system.

The second system may be party to the call (or party to the call being initiated). However, the second system may be an intermediary and not party to the call.

The communications system may be arranged to maintain the connection beyond the end of the initiation phase of the call.

At least one of the first system and the second system may be arranged to output data to its user as at least a part of said dialogue, the output data being dependent on data dialogue received over said connection.

At least one of the first system and the second system may be arranged to receive a user input as at least a part of said dialogue, the respective first or second system being arranged to transmit data as part of said data dialogue to the other of the first or second system in dependence on the received user input.

The second system may be arranged to authenticate the first system or its user via the dialogue.

The data dialogue may include or define a user interface of options to route the call, the recipient system of the data dialogue that defines the user interface being arranged to output the user interface and accept user inputs in dependence on said options, the recipient system being further arranged to transmit data on one or more of said user inputs as part of the data dialogue.

The recipient system of the data on the one or more user inputs may be arranged to connect said call in dependence on said user inputs.

The stored data preferably includes call context data defining one or more options from the user interface, the call context data being arranged upon selection to trigger a call initiation from the system storing the data and a data dialogue in dependence on the call context data.

One or more of the first and second systems may include stored viral data and is arranged, upon establishment of the connection to transmit the stored viral data to the other respective system.

At least part of said data dialogue may comprise a payment authentication, at least aspects of the data dialogue or establishment of the call communication phase being dependent on success of the payment authentication.

The stored data may include call context data defining at least attributes of a call, the call context data being arranged upon selection to trigger a call from the system storing the data.

In dependence on said data dialogue, one or more of said first and second systems may be arranged to communicate with a further system.

According to another aspect of the present invention, there is provided a communication method comprising:

causing establishment of a connection between a first system that is a party to a call, or is a party to a call being initiated, and a second system;

communicating between said first and second systems via said connection, the communication comprising a data dialogue that is separate to initiation communications for the call; and,

storing data, or to causing a change to an application or data or process at one of the first or second systems in dependence on the data dialogue.

The method may further comprise operating or interfacing with a management system to manage and/or monitor at least aspects of the call, the management system causing establishment of the connection.

The method may further comprise causing establishment of the connection upon receiving initiation data on the call at the first system.

The method may further comprise maintaining the connection beyond the end of the initiation phase of the call.

The method may further comprise outputting data to a user in at least one of the first system and the second system as at least a part of said dialogue, the output data being dependent on data dialogue received over said connection.

The method may comprise receiving a user input in at least one of the first system and the second system as at least a part of said dialogue, and transmitting data as part of said data dialogue from the respective first or second system to the other of the first or second system in dependence on the received user input.

The method may further comprise authenticating the first system or its user via the data dialogue.

The data dialogue may defines a user interface of options to route the call, the method further comprising outputting the user interface at the system receiving the data dialogue that defines the user interface, accepting user inputs in dependence on said options, and transmitting data on one or more of said user inputs as part of the data dialogue.

The method may further comprise connecting said call at the system receiving the data on the one or more user inputs in dependence on said user inputs.

The stored data may include call context data defining one or more options from the user interface, the method further comprising, upon selection of the call context data triggering a call initiation from the system storing the data and performing a data dialogue in dependence on the call context data.

One or more of the first and second systems may include stored viral data, the method further comprising, upon establishment of the connection transmission of the stored viral data to the other respective system.

At least part of said data dialogue may comprise a payment authentication, the method further comprising preventing at least aspects of the data dialogue or establishment of the call communication phase until success of the payment authentication.

The stored data may include call context data defining at least attributes of a call, the method further comprising, detecting selection of the call context data and triggering a call dependent on the call context data from the system storing the data.

The method may further comprise communicating with a further system in dependence on said data dialogue.

Embodiments of the present invention may be implemented in hardware, software, firmware, some combination thereof or in any alternative medium. As such, in one form the invention can comprise program code encoded on a computer readable medium such as an optical or magnetic disc, flash or other memory device, or firmware. The program code encoded on the computer readable medium is operable to be executed by a computer, once read, to cause a processor to perform steps in accordance with the program code.

Preferably, the connection comprises a peer-to-peer connection. Preferably, the connection is established as a separate entity to connections supporting call initiation, the communications phase etc.

It is important to note that the connection can persist as long as desired and may not terminate at the end of the initiation phase. Indeed, the dialogue may not even occur during the initiation phase. The connection could even persist after the call itself has terminated.

In one embodiment, the communications system is part of the recipient system. In alternate embodiments, the communications system may be remote of the recipient system, or may consist of component modules residing on both the recipient and originator systems.

The communications system may provide call routing, call screening, secure access or other services including commercial or non-call related services.

The originating and recipient system may each be one of a mobile telephone, an application running on a computer, an IP telephony client, a fixed line telephone, a video phone, or a teleconferencing system.

Embodiments of the present invention may be implemented in software, firmware, hardware or some combination thereof. Embodiments may be pre-installed and/or integrated into systems or may be available as installable ad-ons.

Using an embodiment of the present invention, the originator may be offered information or some form of interaction concerning and/or defined by the recipient prior to completion of the initiation phase. For example, the interaction may enable routing in an automated system to be selected in advance without the need of navigating the IVR system. Vice-versa, a recipient may be able to negotiate or otherwise discuss issues with the originator or other device such as authentication, encryption and the like using the data dialogue.

In optional embodiments, the call may be:
Re-routed from the recipient to another system to enable screening, advanced processing, personal number type facilities or other services; or
Rejected by the recipient subsequent to an exchange of data between the recipient and the originator, such data to be stored for subsequent use by either party.

In preferred embodiments of the present invention, the originator receives information over a peer-to-peer connection with the recipient during or in place of ringback.

For example, in a call to a call centre, such a connection could interface with other call centre's IVR system and generate a ‘ringback’ on the originator device showing the available IVR options prior to the call being set up. The calling party would therefore, effectively, be able to define the routing for the call prior to the communication phase.

It will be appreciated that this is different to conventional systems such as those described above in which a data dialogue does not take place. The only “data” provided to the originator is the ringback (ringing/busy/unobtainable dial tone) which is:
generated by the network not the recipient; and/or
is not provided over a separate connection; and/or
is restricted to the transmission of data relating to the establishment of the communication phase.

### BRIEF DESCRIPTION OF THE DRAWING FIGURES

Examples of the present invention will now be described with reference to the accompanying drawings, in which:

FIG. 1 is a schematic diagram of a communications system incorporating an embodiment of the present invention;

FIG. 2 is a schematic diagram illustrating data communications in the embodiment of FIG. 1;

FIG. 3 is a diagram illustrating an alternative embodiment of the present invention;

FIGS. 4, 5 and 6 are schematic diagrams illustrating other embodiments of the present invention.

### DETAILED DESCRIPTION OF CERTAIN EMBODIMENTS OF THE INVENTION

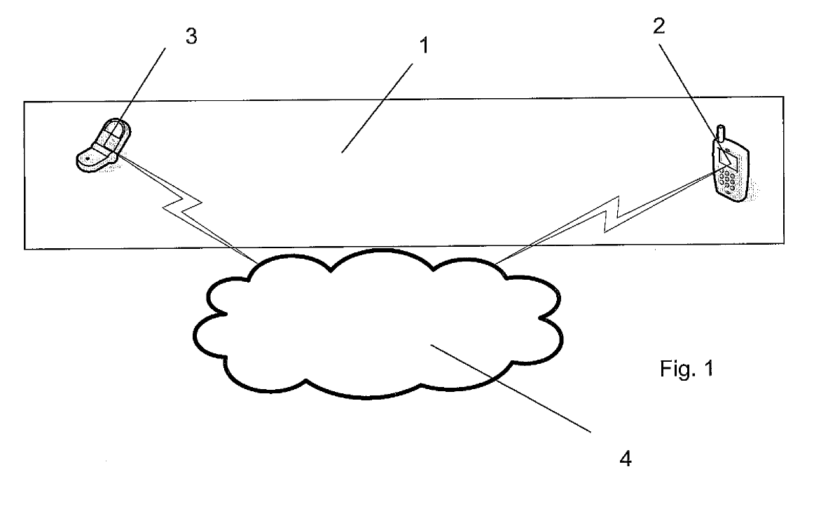

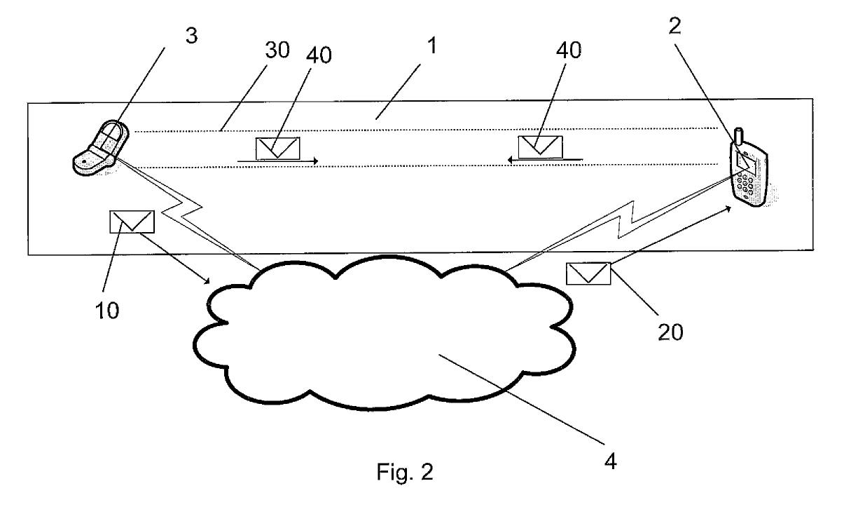

FIG. 1 is a schematic diagram of a communications system according to an embodiment of the present invention. FIG. 2 is a schematic diagram illustrating data communications in the embodiment of FIG. 1.

The communication system includes a first system (the originating system) 3 and, a second system (recipient system) 2 interconnected by a network 4.

The originating system and recipient system are to be parties to a call. In order to establish the call, the originating system 3 triggers an initiation phase of the call by issuing a request (shown as data packet 10 in FIG. 2) to the network 4 for a connection to the recipient system 2.

The network establishes identity data on the recipient system 2 based on identifying information provided by the originating system 3. The identity data may include location, identity and/or other necessary information on the recipient system 2. In the case of mobile telephony this identity data includes the MSIDN, commonly known as a telephone number. For instant messaging or other services this may be a more general IP address and/or “user id”.

Once the network 4 has established the identity data for the recipient system 2, it sends session initiation data 20 to the recipient system 2. The session initiation data includes technical details of the communication session such as codec information for a video or audio call, or code pages for text communications.

Embodiments of the present invention differ from conventional communications system at this stage. Conventional communications systems would, at this stage, announce the call to the recipient user and then establish the communication phase enabling user to user communication.

In contrast, in preferred embodiments of the present invention the recipient system 2 is arranged, upon receipt of the initiation data 20, to establish a connection 30 to the originating system 3 and engage in a dialogue in which each of the first and second systems provide dialogue data 40 to each other

The initiation request may contain special information to be used to identify calls/parties that support dialogue. For regular telephony this may be an extension to the caller-line ID, for SIP it may be a special code in the subject line, with similar approaches for other session initiation mechanisms.

For example, the originator may flag its outgoing call initiation request with data that identifies it as supporting dialogue. If the recipient system also supports dialogue then the above process would be triggered, otherwise the call would proceed as normal. Flagging of the initiation request is not essential and other mechanisms can be envisaged. For example, a recipient that supports dialogue may automatically attempt to establish a connection to the originator for each call received irrespective of whether the initiation request included a flag or other data. Similarly, address book functionality could be provided so that an originating or recipient system may have a-priori knowledge (programmed by a user or obtained due to previous use) that dialogue is supported. There may also be embodiments in which a central (or distributed) server is used for registration that dialogue is supported. This may enable logging of IP addresses or the like so as to map a received call to the IP address of the device.

Note that there may also be instances where the originator initiates the connection 30 and/or dialogue 40. This may be asynchronous to the initiation phase of the call (so that security, encryption or the like could be negotiated separately of the initiation phase).

The initiation phase is not normally considered successfully complete until the user of the recipient system 2 agrees to accept the call, at which point a synchronous communications channel 50 is established and the communication phase starts. However, in selected embodiments of the present invention, the initiation phase may be considered complete at an earlier stage. In such embodiments, a management phase is introduced between the initiation phase and communication phase so that once the initiation phase is complete, the notification phase starts and the communication phase only starts once the management phase has been completed and the call accepted.

It will be appreciated that the introduction of a call management phase may enable the recipient to manage calls from multiple originators simultaneously with a view to optimising call handling procedures prior to the communication phase.

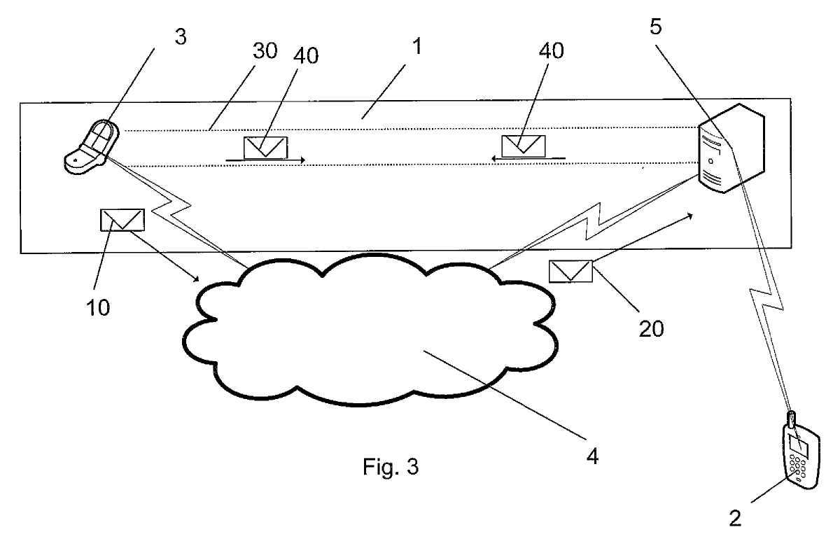

In an alternate embodiment, as is illustrated in FIG. 3, an intermediate system 5 intercepts (or otherwise receives on behalf of the recipient system 2) the call initiation data.

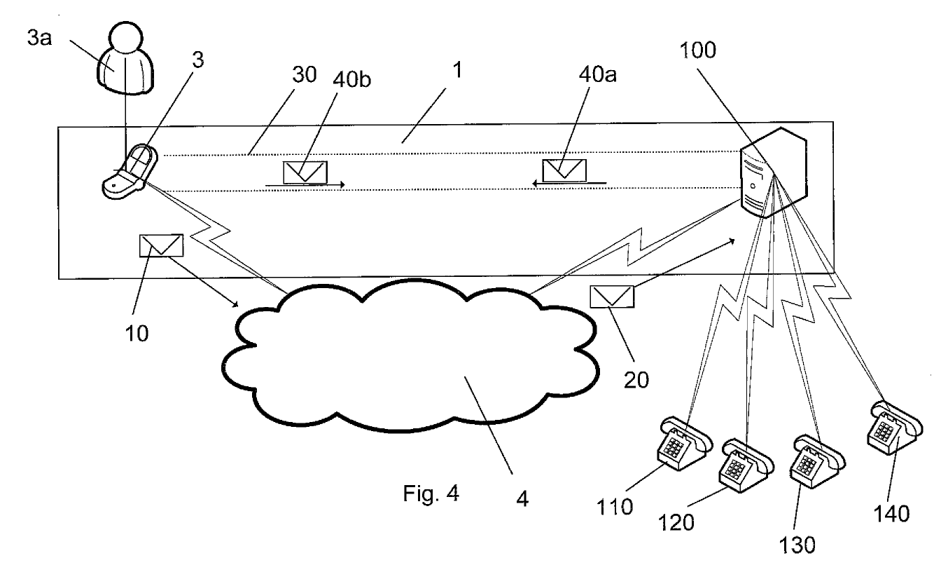

In this situation, the connection 30 is established between the intermediate system 5 and the originating system 3 and data dialogue exchange takes place between the two systems as is illustrated in FIG. 4.

Upon receipt of the call initiation data 20, the intermediate system 5 can offer other types of functionality discussed above on behalf of the recipient system 2. In such a scenario, call screening, secure access via authentication such as pin codes etc, call routing and other functionality can be offered as a service to recipients that do not have systems normally capable of such functionality.

It will be appreciated that the intermediate system may be an intermediate for the originator 3 as opposed to the recipient 2 (ie. the connection and data dialogue is between the recipient 2 and intermediate 5).

Other implementations and applications can be envisaged that may form embodiments of the present invention.

Each party can preferably configure whether their device/system will accept, reject or prompt for a decision on dialogue requests

As most mobile telephones allow multiple profiles, it is preferable that profiles are made aware of dialogue and include settings to allow dialogue to override the profile settings. For example, a profile may allow dialogue to give certain or all users the ability to override a “quiet” or silent ringtone.

The data dialogue exchange may, for example, include:

| Activity at second system | Activity at first system |
|---|---|
| Pre-call routing: Provision of routing | Display or output of routing options; |
| options in advance of a call (instead of | acceptance of user or system inputs on |
| use of an IVR system during the call); | routing options; communication of |
| connection of call dependent on routing selection(s) | inputs or data on inputs to first system |
| Context/Availability: Provision of | Display of received data; acceptance of |
| availability data or other contextual | user system input on further action; |
| data on first system or user; action | communication where necessary to |
| based on request received | first system (eg request to interrupt |
| | call, override quiet profile . . . ) |
| Caller Authentication: Request of caller | Display and/or processing of |
| authentication; processing of call | authentication request; acceptance of |
| based on authentication data | user or system input on authentication; |
| | communication of authentication data |
| | to first system |
| Remote Payment: Request for | Processing of request and |
| payment by call; authorisation of payment | authorisation; charging |
| Contact/Data Management: Pushing | Receipt of data and storage or |
| contact/updates/links | updating of addressbook/favourites |
| Call management: Request for access | Display or processing of access data |
| data; processing or rejection of call | request; acceptance of user or system |
| based on access data received | inputs on access data; communication |
| | of inputs or data on inputs to first |
| | system |
| Anonymous/Controlled callback: | Storage of data in system, triggering of |
| Provision of data enabling a call to a | call in dependence on data |
| predetermined but potentially concealed number | |
| Viral applications: Data is propagated | |
| as a result of a dialogue | |

Embodiments of the present invention using such data dialogues are discussed below. It will be appreciated that embodiments of the present invention may cover many and varied applications, user bases and technologies beyond those discussed.

### Pre-Call Routing:

Embodiments of the present invention may enable provision of routing options in advance of a call (instead of use of an IVR system during the call). In conventional systems, if you call a large organisation such as bank or the like you are presented with an interactive voice response system (IVR) or similar which offers a menu of options and connects you to a department or operative based on the option(s) you select when navigating that menu. Not only is this time consuming and tedious, you are also paying for the call from the moment the IVR system kicks in (because it is done during the communication phase). It also avoids infuriating, drawn-out options presented by a celebrity soundalike.

Caller can be presented with a faster, more intuitive (preferably visual) solution in which a routing menu on their handset or device presents a series of options and ensures they get through to the right operative. Optionally, the system may alert the operative to the call context established by the user's choices.

In an embodiment of the present invention as illustrated in FIG. 4, the second system 2 includes an IVR system 100. Calls that do not support dialogue are passed to the IVR system 100 for processing and connection to an appropriate operative 110-140. Where the call supports dialogue, the second system makes the connection 30 back to the first system and provides data 40a on call routing.

The data 40a may be an entire interface to be presented by the first system to the user, data (such as XML) defining an interface and options to be rendered or otherwise output on the first system 3, an encoded menu structure to be rendered or output by the first system 3; or any other data that enables selection of call routing. The data may be communicated to the first system 3 in its entirety or in a piecemeal fashion (such as menu by menu).

Upon receipt of the data 40a, the first system processes the data 40a and, where necessary, outputs options to the user 3a. The user 3a selects appropriate options to navigate the menus. Where a decisive point in the menus or options is reached (such as an operative 120 is linked to a selected option or more of the menu structure is needed), the first system sends data 40b back to the second system. If necessary, these steps are repeated with processing of the received data 40b at the second system and provision of further data 40a. If an operative 120 is selected then the second system 2 attempts to connect the first system 3 to the operative 120. Should the operative be unavailable and/or connection not possible then this may too be communicated to the first system 3 for further decisions (although those further decisions overlap with other embodiments discussed below).

The communications system 1 may include a facility enabling the first system 3 to “save” its position within the options or menu structure of the second system 2 for future use. In this situation, call context data 50 is stored in an appropriate part of the first system 3 and selection of an appropriate option or user interface allows a call to be placed that bypasses preceding options or menus.

Embodiments of the present invention may be combined. For example, caller authentication may occur before pre-call routing and modify the options/menus that are available to the caller.

If the originator was to call their bank and there was nobody available in the selected department, data akin to a ‘cookie’ could be transmitted over the connection 30 to the originating system 3 that could then be activated at a later date to present the originator with the ability or a special incentive to call back. In this situation, the recipient (the bank department) does not necessarily have to provide the originator with a telephone number to call (this would be embedded within the cookie but may be encrypted or otherwise protected). This would enable IVR based systems to be bypassed on a one-time occasion or potentially enable the originator to contact the recipient during a predetermined time window.

Not only could such functionality be used in place of or in conjunction with IVR systems and the like to enable the originator to call back to the intended recipient without needing to navigate the IVR system again, it could also be used in dating, small advertising and other applications where the two parties want to communicate but do not necessarily want the other to receive their phone number. In such arrangements, an intermediate system similar to an IVR will accept a call from an originator and provide the cookie or similar data enabling the originator to subsequently call the recipient. The cookie can be arranged to have limited use, be time barred or have other restrictions associated with it.

In one embodiment, User A may originate a call from their device (Device A) to their bank. The bank receives the incoming call using Device B, and the call may or may not be answered by an operative at the bank (User B).

In this example, during or prior to the call origination, an alert or aspects of an alert may already exist on, or be created dynamically on the A device, optionally in dependence on input from User A or some other process

For example, to avoid misuse by a third party, when the call origination process begins, an alert management program running on the A device might recognise the bank's number and request security confirmation (perhaps the entry of the nth and n1th digit of their customer number) or other user action before validating and/or constructing the relevant alert and enabling it to be used in association with the call.

Once User A has correctly complied with the requirements of the alert management program (if any), the call is set-up and signalled over the telecommunications network to Device B, which accepts the call.

Device B may then suspend alerting of User B (and perhaps also signalling of user alerting to the relevant originating network, entity and/or device) while it opens the separate data communication connection with Device A, retrieves the alert data from Device A, and analyses or otherwise processes it.

This process could include Device B communicating with the bank's security system to verify the customer number encapsulated within the alert data and, having done so, proceeding to alert User B, the bank operative, using the notification element of the alert data acquired.

In this example, however, the alert process could extend beyond the notification phase into the voice communication phase. This may require that both devices are able to maintain simultaneous voice and data communications, as is possible for example on a GPRS Class A device.

When the bank operative User B answers the call, the alert data is processed by her terminal to display the customer number and other customer data encoded within the alert and to use such data to call up additional information from the bank's internal systems if required. A similar method is already in use for associating user information with CLI call data, but in these cases the CLI call data is necessarily limited by the structure of the CLI and related protocols. Using an embodiment of the present invention, the data exchanged for processing may be greater in volume and/or more varied in format or content.

The bank operative is then able, using an application on her terminal that is able to process and/or execute or otherwise depend on elements of the alert data, to generate an event on User A's device.

For example, he or she may welcome User A to the service over the voice connection, then inform User A that they are going to request User A to enter two digits from their user PIN using their telephone keypad. He/she asks User A to follow the instructions on the screen of their device.

Device B, in dependence on input or other actions from User B, now triggers and controls this process or application on User A's device.

User A's device displays on the screen the message: “Please enter the first and third digits of your PIN number”. User A enters the numbers or other data and the application on User B's terminal accepts and processes their input, validating the PIN entry.

Note that one advantage of this system is that User B is not aware which digits of the PIN number are being requested by the system.

Furthermore, the above alert process may not terminate until the call itself, including the voice communication phase, is over. For example, it can be useful to have a clear record of calls made that includes not only time, date, duration and dialled numbers, but also includes other data that may have been generated during any phase of the call itself and stored or otherwise acted upon in some manner by the alert process. In this case, for example, the user may order a cheque book during their call with the bank. The operative User B then enters details of this request on their terminal. This information is communicated via the alert process over the connection already established to the Device A, which on conclusion of the call notes not only the time, date etc but also the fact that a new chequebook was ordered during the call.

It will be appreciated that the following are possible:

Continuing to execute a single process or application or set of related communicating applications or processes during the transition from call origination through call-set-up to call reception to user alerting to the voice communication phase and finally through to and beyond the call termination process;

Enabling control over such processes or applications to be exercised from time to time by either the A device or the B device, depending on negotiation between the devices and/or their applications, and/or depending on user input on either device, or other events;

Enabling data to be exchanged between the processes and/or applications over a separate persistent communications connection before, during and after the pre-call, communication, and termination phases;

Enabling such data to be exchanged not only between Device A and B, but between other addressable entities as required;

Enabling the call notification and/or other call related processes (for example, automated navigation of an IVR tree) to be defined, modified and/or executed dynamically at any time during the call process, in dependence on user behaviour at any time during that process and/or on other events or triggers

These possibilities can offer significant advantages over a purely notification based-system which by logical definition can only refer to events taking place prior to the voice communication phase (as a notification is terminated when the call is accepted by the recipient).

Note that the ‘alert’ data package could include data that isn't for a notification.

It is always important to distinguish in these cases the differences between a user and their device, and between a device receiving a call and a user accepting that call.

The connection established (separate or not) is able to include other entities and not just the other device.

### Context/Availability:

The terms context and availability can have many meanings. For example, the availability of a recipient system may be dependent on:

Availability of a user. For example, he or she may be:
in a meeting;
on holiday;
off sick

Availability of the system—the system may be:
in the communication phase (or initiation phase) of another call;
low on battery;
in an area of limited reception for signals;
overseas (and on a network which is more expensive to accept calls);
in a specific predetermined location (eg, the user may have previously defined a location of a conference room via GPS).

In each case, the recipient system 2 may be arranged to respond to call initiation data by setting up a connection 30 to the originating system 3 and transmission of availability or context data 40 for output at the originating system 3 to the user 3a. The originating system 3 may then offer the user the ability (preferably only if indicated by the recipient 2 that it will accept it) to go ahead with the call, leave a voicemail message, leave a callback request (discussed below) or terminate the call initiation.

Where the originator wishes to go ahead with the call leave a voicemail or a callback request, this is communicated to the recipient system 2 and processed accordingly. The recipient system 2 may optionally allow certain originating systems 3 the ability to override its current profile (eg silent, straight to voicemail . . . ) based on the outcome of the dialogue.

In the case of callback requests, embodiments of the present invention preferably enable the saving of data to one of the first and second systems' devices that prompts or permits callback. This is different to a missed call as the call did not complete—it is simply a request for the user to call back. The data defining the callback may be time limited (eg expire after a certain time or date or only allow the callback during a certain time window such as 9 am-5 pm Monday to Friday). The callback request may also conceal the caller's number to the recipient (see below for further details).

A further option may allow the originating system 3 to annotate or customise an entry in a call log. For example, if the user proceeds with a call but it is not answered, the originating system 3 may be permitted to provide an annotation (eg—not important; ring me asap . . . ) to the missed call entry listed on the recipient system 2. Optionally, the originating system 3 may be given the ability to remove its entry in the call log on the recipient system 2.

Context may also be taken into account during call setup. For example, embodiments of the present invention may enable the user of the recipient system 2, on receiving a call notification, to initiate dialogue with the originating system 3 to provide some alternate ringbacks such as text or voice stating:

“I'm busy, call me back in 5 minutes”;

“I'm currently accepting/not accepting [define the category] calls only” This ringback enables you to put off business, or private, or sales or other calls . . . .

It will be appreciated that such options could be predetermined (ie a default, programmed or profile linked behaviour) or they could be selected in substantially real-time via a user interface presented by the recipient system during the call initiation phase.

Call context may also be applicable to conference calls. The dialogue may provide a graphical representation of the parties who are online before the call is joined.

In the case of low battery and poor connection/reception warnings, the originator or recipient would get a warning before the call connects, so that they have the option to change their minds about the call or to keep the conversation as short as possible. For connection/reception, the recipient system (or indeed the originating system) may monitor its connection current or historic status. If you have been experiencing frequent drop outs or the current connection is very weak, your callers are warned before placing the call.

Display of received data; acceptance of user system input on further action; communication where necessary to first system (eg request to interrupt call, override quiet profile . . . )

### Caller Authentication:

In the case of caller authentication, handsets could use the connection/channel when connecting parties (such as customers with banks and other institutions) for providing identity confirmation using PINs and other procedures. These systems could work both ways, enabling you to reassure your bank that you are who you say you are, and your bank (when calling you) to ensure that the right person is answering the phone before the call is initiated.

This data itself could of course be encrypted with the key exchange taking place first or in advance based on some registration procedure and stored in an addressbook or the like.

### Remote Payment:

If you wanted to pay for parking, a traffic toll or congestion charge or there is a long queue at the checkout, you could dial an advertised number.

As part of call initiation, a connection to a payment authority is established and the dialogue includes agreement/acceptance of price to be paid. Payment authorisation is then made via the requesting party (which may be to some payment mechanism already registered at the payment authority or associated with the originating system or a reference to an account/credit card to be charged.

Once the payment is processed, the call is put through to an operative or pre-recorded message for further processing where necessary.

Note that the payment authority need not be the person/organisation providing the product/service to be paid for. An optional receipt could be stored on the originating system and could optionally be associated with the call in the call Log.

### Contact/Data Management:

Each time a user makes or receives a call, his system could automatically check to see if there is an entry for him or her in the other party's address book, check for correct details and add or update details that are missing.

In another embodiment of the present invention, a caller might configure their telephony device to originate and manage outgoing and incoming calls in dependence on or in some other relationship to a social networking website.

Social networking websites such as MySpace and Facebook enable users to create their own ‘pages’ (user nodes) which may incorporate material that links to (is ‘tied’ to) other user nodes.

A mobile phone may in this context be viewed as a node and the call patterns associated with the user of that node may be considered ties to other nodes.

As an example of how aspects of the present invention might be used, the originator A might configure their telephony device in respect of a call to a recipient B by establishing a communications link between that device and a social networking website as part of the call process.

For example, A might create an alert on their device for use in notifying B of their call by acquiring presence data, images, messages, or other data from the social networking website and using that data to generate the alert. The recipient B may be subscribed to the same social networking website and in that case the two devices could use data generated as a result of the call process to update their social networking site pages and to create new ties between nodes—by, for example, scanning calls made on each device to other individuals, thereby creating a map of an ad-hoc communications network, and representing the relationships between the nodes of that network within the context of the social networking site. If A calls B, C, D and E and E calls F, G, H and I—and A, E and H are members of the same network, then new ties could be created within that network linking those three members, such ties characterised by data representing to other users the calls that took place and any other appropriate data arising from them, subject always to the application of user control policies to protect privacy and maintain suitable preference settings.

Furthermore, many social networking sites now allow users to post photographs. Since many modern mobile telephony devices have digital cameras incorporated, it would be possible to take a picture of one's surroundings, use it as a visual alert for a call to a friend, and simultaneously connect during the call set-up process to the social networking site pages of both parties, uploading the photograph and associating it with further status or presence data generated as part of the call alert process described elsewhere in this application.

It will be appreciated that such examples benefit not only from the communication of alert data between the originating and recipient devices, but also on the establishment (as part of the alert process) of connections with other systems and entities and the modification, during the call notification phase or at some other time and in dependence on user interaction with the alert or otherwise, of data or control of systems on those other systems and entities.

### Call Management:

In addition to caller authentication discussed above, an originator or recipient could apply various call filtering techniques. For example:

A caller quiz may only accept calls from people who fulfil certain criteria (such as who answer correctly a series of questions). This could be for some promotion (in which the call to give your details to receive a prize or offer only enters the communication phase if you are successful) or for pre-filtering of job/flat-share/lonely hearts enquiries.

Similarly, questionnaires could be offered to callers and terms and conditions could be displayed or otherwise output with the call only moving to the communication phase if the terms and conditions are accepted by the originator/recipient.

The data obtained may provide the calling party with more information about a user's interest or eligibility before connecting the call and could in certain cases result in the caller terminating the call.

### Anonymous/Controlled Callback:

Embodiments of the present invention enable the calling of a party under controlled circumstances. While this will typically be in response to a previous call (or a previous attempted call), it will be appreciated that the dialog mechanism could be used without leading to a call. For example, the dialog could place data or a token on a user's system that allows a call to be made under controlled circumstances and then terminate before a communication phase is ever established.

Controlled circumstances include time controls and suppression of called number such as discussed above. Additionally, the circumstances could be specified such that the call type/mechanism is designated (so that a free call or particular network could be designated).

In this manner, operatives can ensure that the customer's handset/system retains a record of their call including its subject or any other important information (e.g. a sales reference number). The customer can subsequently use this ‘card’ to generate a call free of charge—and that call will automatically be directed to the right person. The operative's system could even use bundled data to call up the relevant details before connecting the call (avoiding the use of IVR filters). Note that ‘call return’ features could conceal the number to be called, preserving anonymity if required. This could be useful if you're calling a blind date.

Viral messages (see below) could also be distributed and offer similar functionality. Selection of a viral message may enable you to call any qualifying number free of charge in return for viewing/hearing a sponsored alert and/or permission for transmission of the viral message. When the call is completed, a copy of the voucher is optionally:
left in the call log of the recipient for them to use in their turn
erased from the call log of the caller (for limited use vouchers)

It may be the case that you must give permission for the viral message to be distributed a number of times (all of which are recorded in data associated with the viral message on the user's system) before you receive a free call.

### Viral Applications

Embodiments of the present invention may be used in handling of viral distribution of data, offers and the like. One application is mass call campaigns. For example, if a TV show publishes a dial in number, the call management phase could be used to manage the callers prior to the communication phase—and by introducing interactive features into the call management.

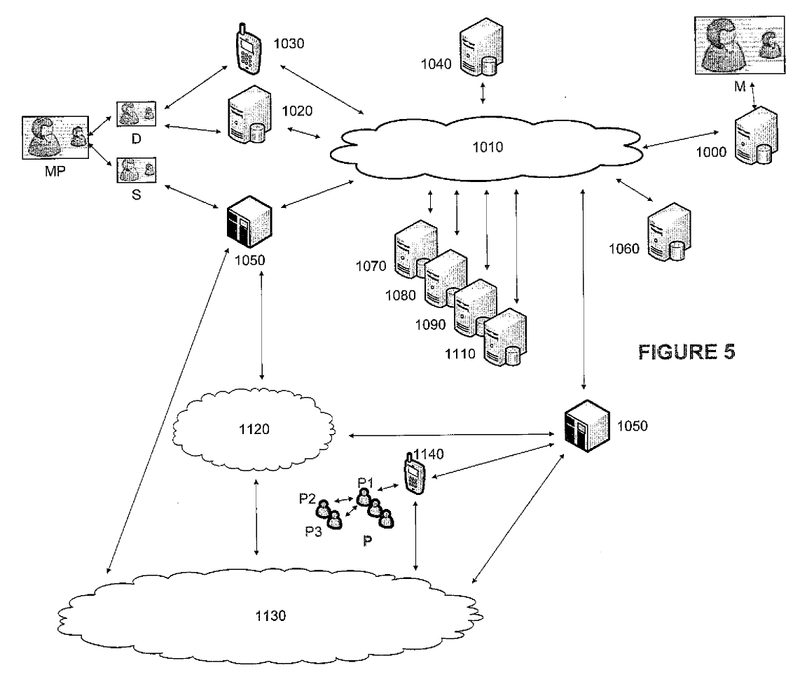

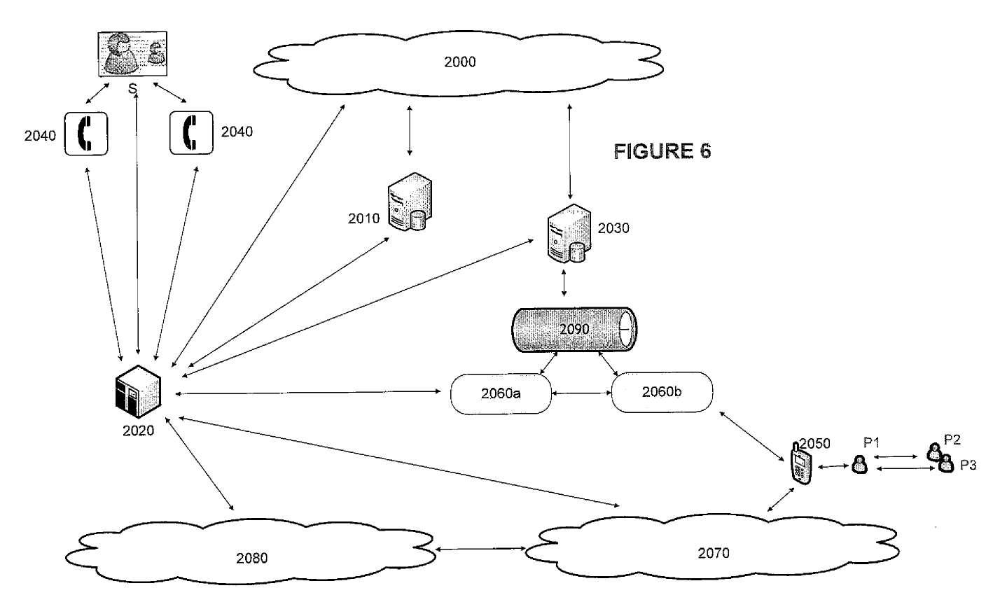

In the example illustrated in FIGS. 5 and 6, a magazine publishing corporation (MP) uses an embodiment of the present invention to launch a viral advertising campaign.

The campaign includes an interactive notification (an ‘alert’), which may incorporate visual and/or other media as well as computer data instructions for execution by an application running on a device. Alternatively the alert may itself be the application, being in the form of an executable software program, sub-routine, function or process.

The device may, for the sake of example only, have been instrumental in making a call and in the process thereof receiving or delivering the alert.

The application may be arranged to carry out further actions including for example opening of subsequent data and/or voice communication sessions with other entities or individuals. The application may be arranged to trigger the further actions in response to internal and/or external and/or user-generated events or conditions.

An alert may incorporate the resources or other data required to, for example:
provide aliases or references to such data in the form of URLs or otherwise;
process and/or generate and/or represent multiple notifications or variations thereof, the alert therefore being capable of self-modification;
determine in what manner the alert may be virally transmitted to subsequent recipients, for example it may specify that it is to be transmitted onward only to recipients with a London UK (020) dialling code;

In this example, the alert presents the call recipient with various questions which, if answered correctly, enable the recipient to accept a sales call (or at a later date to initiate a call to a sales agency or other third party or device) or carry out some other action and claim a prize.

In one example, the value of the prize may be increased if during the call the recipient accepts a trial subscription to the magazine published by the magazine publishing corporation MP.

The recipient may be further incentivised to spread the alert to his contacts, for example by receiving call credits for each call made that passes the alert or a version thereof to the recipient. The recipient's device is preferably arranged to store the alert or a modified version in a memory or other data repository. The alert and memory location may be associated with a specific application (so that if you wanted to benefit from the incentive you would access the application and make calls through it which would allow the application to access and use the alert when initialising the call). Alternatively, the memory may be accessible from the device's operating system and the user may be presented with an option when making a call to use the alert. This might be achieved by changes to the operating system, call system or via a plug-in of some kind.

The manner in which the alert may be further distributed is outlined in more detail below.

Each subsequent contact that receives the alert or a version thereof may be similarly incentivised to call a sales agency or other third party or device and, for example by means of call discounts, to spread the alert to their contacts in turn.

The manner in which the resources for the campaign may be assembled and/or created and the prospects for the campaign may be selected is now described with particular reference to FIG. 1.

For the purpose of this example:
the magazine publishing corporation MP has two relevant departments: a marketing department (D) and a subscription telesales department (S).
a marketing services company (M) hosts an application server 1000 which is accessible over the Internet or other network 1010 to its customers which include the marketing department (D).
the magazine publishing corporation MP wishes to use the marketing services company M to identify suitable end-users (the prospects (P)) for targeting by the campaign and to provide data and call management services in support of the campaign.
The various addressable entities in this example may all connect with each other over the network 1010 or may otherwise exchange data as required for example via other networks or by using removable storage media or by way of operator intervention involving the spoken word, written or other communications.

The marketing department D is able to access the application server 1000 from a remote device such as a fixed terminal 1020 or mobile device 1030 using for example a standard Internet browser or other client software and a secure log-in process. Once access has been established, a user runs an application, which may be hosted by the application server 1000 or otherwise installed on the marketing department D's device, for the configuration of the campaign.

The marketing department D may then use the application to specify various aspects of the campaign including the alert to be used. The alert or any or all constituent parts thereof may:
be stored either locally or remotely on a network accessible device 1040 or on some other storage medium; and/or
have been created by the marketing department D or acquired by it from a third party service and/system and/or content provider or from the marketing services company M.

Aspects of the campaign defined by the marketing department D or otherwise established could include the desired location, demographic information, previous purchasing history and other information relating to the prospects P as well as contact information for the subscription telesales department S or some other party responsible for dealing with respondents to the campaign, such contact information including the non-geographic telephone number of a call centre or call management system or, as in the present example, a Call Management Server 1050, a telephone number for use in communication by S MS, or other data.

This information may have been in the possession of the marketing department D or may have been supplemented or entirely supplied by a third party service and/or system and/or content provider or by the marketing services company M and such supply may have been carried out either contemporaneously or otherwise and/or with or without user intervention.

Once the marketing department D has finished using the local service application to specify and/or collate and/or create the alert and any additional aspects of the campaign as may be required by the design of the software running on the application server 1000 or otherwise, the marketing department D uploads the aforesaid aspects of the campaign (the ‘campaign data’) to the application server 1000. The supply of the campaign data to the application server might be accomplished by other means including the supply of data on removable storage or by word of mouth to a representative of the marketing services company M.

The application server 1000 may then perform various checks upon the campaign data including checks for accounting and authentication purposes as well as for data integrity and other purposes.

The Application Server 1000 then provides such elements of the campaign data, either by transfer on physical media or over a wired or wireless network or by other means as may be appropriate, to a Campaign Manager Server 1060 as required.

In this example, the Campaign Manager Server 1060 is arranged to determine which prospects P should initially be addressed by the campaign. For the sake of example only, it may accomplish this by connecting to a Presence Server 1070, a Subscriber Database 1080, a Policy Server 1090, and a Location Information Server 1110. The Campaign Manager Server 1060 may interrogate the Subscriber Database 1080 for demographic and other user data to determine a shortlist of potential prospects. It may then further narrow down the list of prospects by interrogating the Presence Server 1070 for information on their communications status and location. The Presence Server 1070 in turn maintains a record of each subscriber's communications status by reference to the Policy Server 1090, which manages subscribers' preferences with regard to marketing opt-outs and other functions, and to the Location Information Server 1110 which manages location information received directly from subscribers and their devices as well as from third party location data services (for example a mobile network operators Gateway Mobile Location Centre (GMLC)).

One benefit of a viral campaign may be that the distribution of the media should be made by the prospects P throughout their wider network of peers, so that the media reaches a wider audience and in a shorter time and at less cost to the campaign originator than would have been the case if the prospects were limited to those known to the marketing department D or some other organisation. To maximise this benefit, the Campaign Manager Server 1060 may connect to the Call Pattern Analyser 1110.

The Call Pattern Analyser 1110 may be arranged to carry out continuous monitoring of calls made between subscribers on the Public Switched Telephone Network 1120 and/or mobile operator network(s) 1130 and the storage of such information relating to those calls as might be useful for the future determination of optimum initial recipients of viral material or for other purposes.

In conjunction with the Call Pattern Analyser 1110 and the other system entities and using the campaign data or other resources, the Campaign Manager Server 1060 may determine which subscribers have call patterns and/or contacts and/or are associated in some way with other criteria that would define them as optimum initial recipients O of the media. For example if prospect P1 has made calls to P2 and P3, both of whom are identified as suitable prospects for the campaign, the Prospects Manager may determine that the media be sent to P1 only in reliance of P1's future distribution of the media to P2 and P3.

By this or other similar methods arising from the example illustrated here, a list of optimum initial recipient(s) (the ‘prospect data’) is abstracted from the list of prospects P. In this example, it is assumed that the first call to be made is to P1, who is equipped with a communications device 1140.

An example of the manner in which the calls may be made to launch the campaign and the alerts distributed is now described, with particular reference to FIG. 6. However, it will be appreciate that the architecture discussed is also applicable to the other embodiments discussed in this application.

In this embodiment, communication between addressable entities may be over the network or Internet 2000 or may otherwise involve the exchange of data as required for example via other networks or by using removable storage media or by way of operator intervention involving the spoken word, written or other communications.

It will be appreciated that various functions of the different entities presented in this example may be aggregated within one or more entities and need not necessarily involve separate physical deployments.

For the purpose of making the calls and distributing the alert(s), the Campaign Manager Server 2010 may be connected to the Call Manager Server 2020 operated by or in conjunction with the subscription telesales department S or some other party.

The Call Manager Server 2020 may initiate outgoing calls to prospects and, on answer by the recipient, may transfer the call to the appropriate operator's telephony device, for example a fixed line telephone or telephony-enabled workstation 2040, within the subscription telesales department S or elsewhere. Alternatively, using a media server function, the Call Manager Server 2020 may service all aspects of the call process and communication itself or in conjunction with some other entity.

The contact details of the optimum initial recipient(s) and the alert for use in the campaign may be passed by the Campaign Manager Server 2010 to the Call Manager Server 2020 which may then at a time specified by the campaign data or in accordance with some other event or condition, commence calling the prospects.

The Call Manager Server 2020 may first ascertain that there is an available operative in the subscription telesales department S to handle a call with a prospect. In the event that such an operative is available, the Call Manager Server 2020 then places a call to the prospect P1 over the PSTN communications network 2080 or the mobile network operator GSM/GPRS network 2070 or a combination of the two.

Depending on the network technology involved, the call may be set up using various protocol and network functions or architectures including for the sake of example only JXTA, SIP, DTAP, ISUP, SS7, IN, IMS.

The recipient device 2050 is arranged on receipt of the initiation data for the call to open a separate connection with the Call Manager Server 2020 as may be instructed by the Rendezvous Server 2030.

The Rendezvous Server 2030 may be used to determine the optimum direct peer-to-peer network connection that may be established for each individual call between the prospect's communications device 2050 and the Call Manager Server 2020 for inter alia the delivery of the alert(s) and management of other aspects of the call process as may be required.

Depending on network topology and other factors, the connection may be established directly between the two devices or via a mediated relay function or server 2060 or in some other way.

For the purposes of establishing peer-to-peer connections between the user's communication device 2050 and the Call Manager Server 2020, a key consideration is the role played by Network Address Translation (NAT) and associated firewall functions. As will be apparent to anyone skilled in the art, NAT was originally introduced to preserve the IPv4 address space (by enabling a large number of devices on a network to be addressed by a single external IPv4 address) but by virtue of its modus operandi it may act as a very efficient firewall.

It will be appreciated that various successful techniques have been developed and used in the VoIP world for UDP traversal of NAT (particularly STUN, TURN and far-end NAT traversal with media relay). TCP NAT traversal is more complex, one technique being to tunnel TCP packets over UDP. In order to implement NAT discovery and provide traversal techniques where NAT is used (‘STUNT’), the current example application may operate as follows.

Both communicating devices (the Call Manager Server 2020 and the user equipment 2050) perform presence update and discovery processes by using the Rendezvous Server 2030. The devices each use STUN(T) to discover what type of firewall/NAT router they are behind. Depending on the outcome, a device will know:
whether it is behind NAT; and
what ports are available for it to use.

The Rendezvous Server 2030 operates as the STUNT server for the communicating devices 2020 and 2050 during discovery mode. Once a device has discovered the topology of the network, this process may need periodically repeating because of (a) the mobility of some devices and (b) the possible requirement for a heartbeat mechanism for pushing presence and network and other updates relating to the status of the communications devices 2020 and 2050 to the Rendezvous Server 2030 and informing it of the topology of the devices' networks on a regular basis.

By way of example only, using TCP as the transport, when the Call Manager Server 2020 decides to initiate a call to the user equipment 2050, it sends an out-of-band (i.e. separate from the traditional voice signalling path) message to the Rendezvous Server 2030, identifying the party P1 by reference to the user equipment 2050 or some other associated user data. The Rendezvous Server 2030 may then decide, depending by way of example only on the topology of the network within which the user equipment 2050 is situated, to proceed in one of the following ways:

The connection between the communicating devices may be mediated by the Rendezvous Server, as in the following immediate example. The Call Manager Server 2020 can be given the IP address to initiate a connection to the user equipment 2050 and a ‘Rendezvous token’. The IP address is the public address of the user equipment 2050, but the latter may be behind a symmetric NAT firewall. The Call Manager Server 2020 may then initiate a TCP connection to the address of the user equipment 2050 and appropriate application port number.

The user equipment 2050 may be informed of the impending connection from the Call Manager Server 2020, by communication with the Rendezvous Server 2030, together with the source (public) IP address of the Call Manager Server 2020. The user equipment 2050 simultaneously sends a TCP connection (SYN packet) destined to the Call Manager Server 2020 public IP address.

Both communicating devices now pass the TCP Sequence numbers and connection information to the Rendezvous Server 2030 for the outbound connections. The Rendezvous Server 2030 now sends the Call Manager Server 2020 a TCP packet with the connection ACK masquerading as the user equipment 2050's public IP address (TCP SYN & ACK flags set and correct sequence numbers).

The Rendezvous Server 2030 does the same to the address of the user equipment 2050, spoofing the IP address of the Call Manager Server 2020. The NAT firewalls behind which both communicating devices have been situated have now been ‘fooled’ into thinking they're connected.

At this point the TCP 3rd phase connection state (TCP ACK message) could flow directly between the communicating devices as their respective firewalls have been tricked into a connection state. Both communicating devices 2020 and 2050 may now inform the Rendezvous Server the rendezvous has taken place.

The communicating devices 2020 and 2050 can now communicate directly over their TCP connection and exchange the alert data using an appropriate application-level protocol.

As another example, the communicating devices 2020 and 2050 may not be able to communicate directly and have to be mediated and relayed. In this instance the Rendezvous Server 2030 is used in conjunction with a Relay Server 2060. The Call Manager Server 2020 is again given an IP address to communicate with the user equipment 2050 and a Rendezvous token, but the address is actually the address of the Relay Server 2060a.

The Rendezvous Server 2030 in parallel (via a distribution function 2090) informs the Relay Servers of the pending connection between the devices 2020 and 2050. The Rendezvous Server 2030 also passes on the request for a connection to the user equipment 2050, but again passes the IP address of a Relay Server 2060b. The Relay Server is instructed to create a listen socket along with the genuine TCP socket so the sequence numbers of the connections can be (sniffed) aligned.

The communicating devices 2020 and 2050 connect to the appropriate Relay Server 2060 (both are instructed to use the same destination port number). The relay server 2060 can see these connections and can pass the TCP Sequence information back to the Rendezvous Server 2030 for rendezvous of the sequence numbers across the two connections.

The Call Manager Server 2020 may now push up the Rendezvous Hello with the token. This is passed back to the Rendezvous Server 2030 to ensure the rendezvous, together with connection information from each Relay Server 2060. The Rendezvous Server instructs the Relay Server 2060a to ACK the token and the Relay Server 2060b to push the token in a Hello. In this way, the Rendezvous Server knows about both clients and can now complete the rendezvous. This involves spoofing the reply TCP packets using the sequence numbers obtained from the listening socket on each relay.

The Rendezvous Server now instructs each Relay Server 2060 to connect other TCP connections together, in practise using a form of packet mangling. Packets from the Call Manager Server 2020 arrive at its associated Relay Server 2060a. The Relay Server 1060a grabs the inbound packet from the IP stack on the inbound interface and mangles the destination address (to Relay Server 1060b)—effectively performing a destination NAT (DNAT). The routing function inside the relay forwards the packet, using this new destination IP address (and possibly a new port number 13 DNAPT).

The packet arriving at Relay Server 2060b is now mangled in the same way, with a new destination address (in effect the address of the user equipment 2050). Because the Rendezvous Server 2030 spoofed the TCP response packets for each connection, the sequence numbers have been aligned at each end and the connection relaying effectively spoofed too. The relayed packets look to each client as they are genuine packets from their respective connections, because in practise they are. Spoofing of the initial connections to each host and sequence number alignment allows the communicating devices 2020 and 2050 to “talk” directly with each other, via the relay nodes and to exchange alert data and perform other functions.

Once the alert data has been exchanged over a connection that may have been established in a manner similar to the above or otherwise, the user equipment 2050 is arranged to process the alert and to use the alert to present the interactive notification of the incoming call to the prospect P1.

The prospect P1 is alerted to the incoming call by means of the interactive notification. In dependence on the actions taken by the prospect P1 during interaction with the notification and on the data communication or dialogue between the recipient and calling device, a number of separate processes may be initiated or modified including, by way of this example:
the creation and storage of a modified alert on the device 2050 or on some other addressable entity that encompasses instructions or other resources required to determine the future viral distribution of the alert or a version or versions thereof during calls made by the prospect P; the alert being a data object that, perhaps but not necessarily in conjunction with software resident on the recipient or sending device as the alert itself may function as a software agent and be self-modifying or capable of self-execution, may be arranged to be presented to the owner of the device via a special menu option. Such menu option could by way of example only be presented within the device call log in a special ‘Calls pending’ sub-menu as distinct from ‘Calls Received’ or ‘Missed Calls’ or ‘Calls Made’. The alert may be either in its original form or as modified during the notification process as a result of the dialogue between the two devices 2020 and 2050 or other factors. The alert may also contain for the sake of example only other campaign or prospect-related or accounting/authentication or other data or a combination thereof.
the analysis of the prospect P1's recent call record in order to supplement modify or otherwise alter data held on some other network accessible device or within the alert or elsewhere. By way of example, this or other data may later be used to monitor the efficacy of P1 as a distributor of viral material or for other purposes;
the modification of the alert to include further information, for the sake of example only, tracking information which will enable subsequent analysis of the topology and other characteristics of the network of contacts created by the prospect P1 during subsequent calls and by the recipients of those calls and the calls they, in turn, made to others and so on, such characteristics to include by way of example only demographic information, call frequency and times, call durations and so on.
the updating of processes on the calling and/or recipient device or other entity related to network communications or other processes; for example, an event timer arranged to cause the device in question to open a data communication session with another addressable device or user.
the amendment of call-related or other data held on the Campaign Manager Server 2010 or any other system entity, for the sake of example only for the purpose of accounting for subsidised calls made by prospects.

Once P1 has processed the notification and accepted or declined the call, the alert for future viral calls and/or some other campaign-related or other data object(s) may be stored on his device or some other accessible entity.

To make a free or otherwise subsidised or incentivised call (which may result in the further distribution of the alert and any associated material as required and the construction and distribution of any associated alert or other data object or which may launch some other distinct and possibly related process), the prospect P1 could, by way of example only, open the ‘Calls Pending’ menu and select the appropriate alert icon or other alert representation by reference to its graphical design, animation, sound, textual description, or other attribute or combination of attributes.

On selecting the alert, his device may be arranged to request P1 to specify, by using his address book or some other means, a contact to call using the aforesaid alert, In this case, a different version of the alert (a ‘modified alert’) may be constructed and/or used. Such a different version may be required as, for example, the recipient of the call is expecting to receive a call from the prospect P1 and not directly from the subscription telesales department D.

This modified alert may, for example, include campaign related media but without the option to answer questions or otherwise interact at that time. The modified alert could by way of example, inform the recipient at the conclusion of the call, during the call or during the call set-up process or notification, that a special offer or some other proposition was now available to the recipient together with details of how that proposition could be accessed (for example, by opening the ‘Calls Pending’ menu or some other menu on his device after the current call was finished).

P1 may in future make calls of his/her own volition to his peers including P2 and P3. Depending on the requirements of the campaign, which may have been encoded within the alert now resident on P1's device 2050, the call process may involve the onward transmission of the alert to the devices of P2 and P3, using a process as described above to negotiate a connection between the two devices for the transfer of the alert data.

In this example, a number of problems associated with the management of viral campaigns, of incentivising participants, and of tracking the results thereof are addressed by embodiments of the present invention.

Other embodiments may include:

Ordering a taxi: the dialogue carries the data on your location, destination, etc so that when you speak to the operator, all you need to do is confirm the booking. The operator's system could return information on the delay prior to the call being answered, so that you could cancel the call before confirming if it was going to take too long. Additionally, once the call is complete a confirmation message could be supplied via data dialogue over the connection.

Embodiments could use enhanced profile data to supplement call notification and/or dialogue. For example, when you call a theatre to book seats, the enhanced profile data is communicated via the dialogue so that the operative answering the call knows which seats you like before he answers the call. The results of transactions in previous calls could be stored on your phone and used to supplement or structure notifications in this way.

Automatic birthday calls could be triggered by calendar entries. Similarly, modification of default notifications and ringbacks could be triggered by calendar entries (eg if in a meeting, change to the ‘Don't disturb’ ringback).

Embodiments of the present invention allow any form of data to be sent by the recipient an/or originator of the call to another party that may or may not be party to the call The data is used in further negotiations.

For simplicity, the majority of this document refers to two-party communications, although it will be appreciated that the principles and examples described could also be applied to multi-party communications.

It will be appreciated that the originating system and the recipient system need not be of the same type. Embodiments of the present invention are applicable as long as the underlying communications mechanism used is compatible with both systems. For example, a mobile telephone will be able to enter a dialogue with a fixed line telephone as long as it has the appropriate processing capabilities. A mobile telephone may also be able to enter a dialogue with a VOIP client on a computer. In this situation, the mobile telephone call may be treated as a standard phone call and handled by a VOIP gateway between the mobile telephone network and VOIP network. Alternatively, if the phone can support VOIP natively then no gateway would be needed. If a call is passed through a gateway the preferably the gateway includes facilities enabling the originator controlled call notification data within the initiation data to be translated into whatever format the recipient system requires.

The data dialogue need not be self contained (or ready for output) and may include: references to other sources from which data must be obtained; instructions on how to use the dialogue data (using resources on the recipient system or obtained elsewhere); and, data that requires encoding, rendering or the like by the recipient system prior to output.

The dialogue may be via a peer-to-peer connection, or any other form of connection.

It will be appreciated that it would be possible to implement a number of the above features without dialogue—for example custom recipient controlled ringback which provides a message as to user availability, system availability, an indication of battery level or signal strength or a recipient user's real-time selection of a ringback message.

The various embodiments described above disclose features that can optionally be combined in a variety of ways depending on the desired implementation.

Since the features described are modular, other embodiments based on different combinations of features are also possible.

None of the described features are mutually exclusive, and any combination of may be deployed to achieve the functions described above.

While the invention has been described in connection with certain embodiments thereof, the invention is capable of being practiced in other forms and using other materials and structures. Accordingly, the invention is defined by the recitations in the claims appended hereto and equivalents thereof.

We claim:

1. A communication system arranged to cause establishment of a connection between a first system that is a party to a call, or is a party to a call being initiated, and a second system, wherein the first and second systems are arranged to communicate via said connection, the communication comprising a data dialogue that is separate to initiation communications for the call, wherein at least one of the first system and the second system is arranged to store data, or to cause a change to an application or data or process in dependence on the data dialogue.

2. A communications system according to claim 1, wherein the data dialogue is separate to the call.

3. A communications system according to claim 1, wherein the data dialogue includes each of the first and second systems receiving data from the other respective system and responding in dependence on the received data.

4. A communications system according to claim 1, wherein either of the first or second system is able to take control the data dialogue.

5. A communications system according to claim 1, further comprising a management system arranged to manage and/or monitor at least aspects of the call, the management system being arranged to cause establishment of the connection.

6. A communications system according to claim 1, arranged to cause establishment of the connection upon receiving initiation data on the call at the first system.

7. A communications system according to claim 1, wherein the second system is party to the call or is party to the call being initiated.

8. A communications system according to claim 1 arranged to maintain the connection beyond the end of the initiation phase of the call.

9. A communications system according to claim 1, wherein at least one of the first system and the second system is arranged to output data to its user as at least a part of said dialogue, the output data being dependent on data dialogue received over said connection.

10. A communications system according to claim 1, wherein at least one of the first system and the second system is arranged to receive a user input as at least a part of said dialogue, the respective first or second system being arranged to transmit data as part of said data dialogue to the other of the first or second system in dependence on the received user input.

11. A communications system according to claim 1, wherein the second system is arranged to authenticate the first system or its user via the dialogue.

12. A communications system according to claim 1, wherein the data dialogue defines a user interface of options to route the call, the recipient system of the data dialogue that defines the user interface being arranged to output the user interface and accept user inputs in dependence on said options, the recipient system being further arranged to transmit data on one or more of said user inputs as part of the data dialogue.

13. A communications system according to claim 12, wherein the recipient system of the data on the one or more user inputs is arranged to connect said call in dependence on said user inputs.

14. A communications system according to claim 12, wherein the stored data includes call context data defining one or more options from the user interface, the call context data being arranged upon selection to trigger a call initiation from the system storing the data and a data dialogue in dependence on the call context data.

15. A communications system according to claim 1, wherein one or more of the first and second systems includes stored viral data and is arranged, upon establishment of the connection to transmit the stored viral data to the other respective system.

16. A communications system according to claim 1, wherein at least part of said data dialogue comprises a payment authentication, at least aspects of the data dialogue or establishment of the call communication phase being dependent on success of the payment authentication.

17. A communications system according to claim 1, wherein the stored data includes call context data defining at least attributes of a call, the call context data being arranged upon selection to trigger a call from the system storing the data.

18. A communications system according to claim 1, wherein in dependence on said data dialogue, one or more of said first and second systems is arranged to communicate with a further system.

19. A communication method comprising the steps of:
causing establishment of a connection between a first system that is a party to a call, or is a party to a call being initiated, and a second system;
communicating between said first and second systems via said connection, the communication comprising a data dialogue that is separate to initiation communications for the call; and,
storing data, or causing a change to an application or data or process at one of the first or second systems in dependence on the data dialogue.

20. A method according to claim 19, wherein the data dialogue is separate to the call.

21. A method according to claim 19, wherein the data dialogue includes each of the first and second systems receiving data from the other respective system and responding in dependence on the received data.

22. A method according to claim 19, further comprising either of the first or second systems taking control of the data dialogue.

23. A method according to claim 19, further comprising operating a management system to manage and/or monitor at least aspects of the call, the management system causing establishment of the connection.

24. A method according to claim 19, further comprising causing establishment of the connection upon receiving initiation data on the call at the first system.

25. A method according to claim 19, wherein the second system is party to the call or is party to the call being initiated.

26. A method according to claim 19, further comprising maintaining the connection beyond the end of the initiation phase of the call.

27. A method according to claim 19, further comprising outputting data to a user in at least one of the first system and the second system as at least a part of said dialogue, the output data being dependent on data dialogue received over said connection.

28. A method according to claim 19, further comprising receiving a user input in oat least one of the first system and the second system as at least a part of said dialogue, and transmitting data as part of said data dialogue from the respective first or second system to the other of the first or second system in dependence on the received user input.

29. A method according to claim 19, further comprising authenticating the first system or its user via the data dialogue.

30. A method according to claim 19, wherein the data dialogue defines a user interface of options to route the call, the method further comprising outputting the user interface at the system receiving the data dialogue that defines the user interface, accepting user inputs in dependence on said options, and transmitting data on one or more of said user inputs as part of the data dialogue.

31. A method according to claim 30, further comprising connecting said call at the system receiving the data on the one or more user inputs in dependence on said user inputs.

32. A method according to claim 30, wherein the stored data includes call context data defining one or more options from the user interface, the method further comprising, upon selection of the call context data triggering a call initiation from the system storing the data and performing a data dialogue in dependence on the call context data.

33. A method according to claim 19, wherein one or more of the first and second systems includes stored viral data, the method further comprising, upon establishment of the connection transmission of the stored viral data to the other respective system.

34. A method according to claim 19, wherein at least part of said data dialogue comprises a payment authentication, the method further comprising preventing at least aspects of the data dialogue or establishment of the call communication phase until success of the payment authentication.

35. A method according to claim 19, wherein the stored data includes call context data defining at least attributes of a call, the method further comprising, detecting selection of the call context data and triggering a call dependent on the call context data from the system storing the data.

36. A method according to claim 19, further comprising communicating with a further system in dependence on said data dialogue.

37. A computer readable medium encoded with a computer program, the computer program comprising:
computer program code for causing establishment of a connection between a first system that is a party to a call, or is a party to a call being initiated, and a second system;
computer program code for communicating between said first and second systems via said connection, the communication comprising a data dialogue that is separate to initiation communications for the call; and,
computer program code for storing data, or for causing a change to an application or data or process at one of the first or second systems in dependence on the data dialogue.
